(19) United States
(12) Patent Application Publication
(10) Pub. No.: US 2024/0166251 A1
(43) Pub. Date: May 23, 2024

(54) GROUND TRANSPORTATION VEHICLE

(71) Applicants: Siena Lyn O'Keefe, Minneapolis, MN (US); Omera Syed Asif, Bloomington, MN (US); Benjamin Yehl Kennard, Minneapolis, MN (US); Ana Yanz, Minneapolis, MN (US); Braeden Armstrong Johnson, Eden Prairie, MN (US); Benjamin Ferrell, Minneapolis, MN (US)

(72) Inventors: Siena Lyn O'Keefe, Minneapolis, MN (US); Omera Syed Asif, Bloomington, MN (US); Benjamin Yehl Kennard, Minneapolis, MN (US); Ana Yanz, Minneapolis, MN (US); Braeden Armstrong Johnson, Eden Prairie, MN (US); Benjamin Ferrell, Minneapolis, MN (US)

(21) Appl. No.: 18/514,869

(22) Filed: Nov. 20, 2023

Related U.S. Application Data
(60) Provisional application No. 63/384,348, filed on Nov. 18, 2022.

(51) Int. Cl. B62B 3/00

(52) U.S. Cl. CPC B62B 3/00; B62B 2301/05; B62B 2301/14

(57) ABSTRACT

A ground transportation vehicle includes a container having a bucket, a hook, and a handle, and a suspension system connected to the container and having first and second rockers and bogies, a plurality of wheels, a plurality of wheel connectors, and one or more variable fasteners. A method of operating a ground transportation vehicle is disclosed. Embodiments of the present disclosure provide solutions to ground transportation of supplies from disaster relief distribution sites to the homes or present lodging locations of disaster victims. In particular, solutions of the present disclosure provide efficient and ergonomic ground transportation when compared to conventional techniques currently used.

### CROSS-REFERENCE TO RELATED APPLICATIONS

The present disclosure claims priority to U.S. Provisional Application No. 63/384,348, filed Nov. 18, 2022, the entirety of which is hereby incorporated by reference.

### FIELD OF THE DISCLOSURE

The present disclosure is directed to ground transportation vehicles. More specifically, the present disclosure is directed to ground transportation vehicles for transporting supplies from a distribution site during a disaster.

### BACKGROUND

After a disaster, relief organizations such as the Federal Emergency Management Agency (FEMA), the United States Agency for International Development (USAID), and the Red Cross set up central supply distribution sites to provide relief supplies such as water, food, clean up kits, hygiene kits, comfort kits, and blankets to disaster sites including disaster victims' homes. These organizations lack the capacity to transport supplies directly from the distribution sites to the victims' houses, and also typically do not have any containers or devices to help victims transport the supplies. Instead, victims of disasters must come directly to the sites and hand carry supplies from the distribution sites back to their homes or present lodging locations.

Disaster victims with children most frequently come to get supplies for their families and/or disabled neighbors. After picking up supplies, these individuals need to walk back to their homes or present lodging locations which are typically located two to three miles from the supply distribution sites, if not farther. Supplies are awkward to carry and may weigh more than 35 pounds for a typical family of four, making manual transportation strenuous especially when the terrain is rugged and substantially unpassable. If a disaster victim is carrying supplies intended for others beyond their immediate family, such as disabled neighbors, the journey from the distribution site may be even more arduous given the significant amount of weight being manually carried.

A further concern associated with supply allocation at distribution sites is the sheer number of individuals seeking supplies at any given time. Occasionally, crowds will develop at a distribution site and may fight over supplies. These altercations can be dangerous for disaster victims and relief workers and make supply distribution more difficult for everyone. A disaster victim injured during an altercation may be unable to travel back to their home or present lodging location and instead becomes the responsibility of the relief organization in charge of the distribution site. This further increases stress on the relief organizations and distracts from their main goal of supply distribution to disaster victims.

Due to climate change, disasters are increasing in frequency and severity. For example, rising global surface temperatures will likely have the effect of increasing drought conditions across the world and making storms more intense as higher amounts of water vapor are evaporated into the atmosphere. Experts from the World Meteorological Organization (WMO) estimate that climate change has helped drive a 400% increase in the number of weather-related disasters in the past 50 years, with approximately 11,000 disasters being documented between 1970 and 2019 from weather events, water hazards, and climate extremes. With populations increasing worldwide, more and more people will need to seek the help of relief organizations during disasters. The issues with current supply distribution sites will thus be exasperated making transportation of relief supplies more difficult. As such, there exists a need for a ground transportation vehicle that can assist disaster victims in efficiently and ergonomically transporting supplies from distribution sites to their homes or present lodging locations.

### SUMMARY

The present disclosure provides solutions to, among other things, ground transportation of supplies from disaster relief distribution sites to the homes or present lodging locations of disaster victims. In particular, solutions of the present disclosure are more efficient and ergonomic when compared to conventional ground transportation techniques currently used in disaster relief operations.

In embodiments of the present disclosure, a ground transportation vehicle includes a container having a bucket, a hook, and a handle, and a suspension system connected to the container and having first and second rockers and bogies, a plurality of wheels, a plurality of wheel connectors, and one or more variable fasteners.

In embodiments of the disclosure, a method of operating a ground transportation vehicle 100 comprises supplying a ground transportation vehicle at a distribution site, adding supplies to the container of the ground transportation vehicle, delivering the ground transportation vehicle to a disaster victim, transporting the supplies to the disaster victim's home or present lodging location via the ground transportation vehicle, and returning the ground transportation vehicle to the distribution site. In embodiments, container 110 may be removed by the disaster victim prior to returning the ground transportation vehicle 100 to the distribution site. A new container 110 may then be added to the ground transportation vehicle 100 at the distribution site prior to servicing another disaster victim with relief supplies.

### BRIEF DESCRIPTION OF THE DRAWINGS

Subject matter hereof may be more completely understood in consideration of the following detailed description of various embodiments in connection with the accompanying figures, in which:

FIG. 1 is an example of a conventional rocker-bodie system operating in different terrains.

FIG. 2 is an example of a conventional rocker-bodie system.

FIG. 3 is a perspective view of a ground transportation vehicle, according to an embodiment of the disclosure.

FIG. 4 is a side view of a ground transportation vehicle, according to an embodiment of the disclosure.

FIG. 5 is a side view of a ground transportation vehicle, according to an embodiment of the disclosure.

FIG. 6A is a perspective view of a rocker for use with a ground transportation vehicle, according to an embodiment of the disclosure.

FIG. 6B is a perspective view of a bodie for use with a ground transportation vehicle, according to an embodiment of the disclosure.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

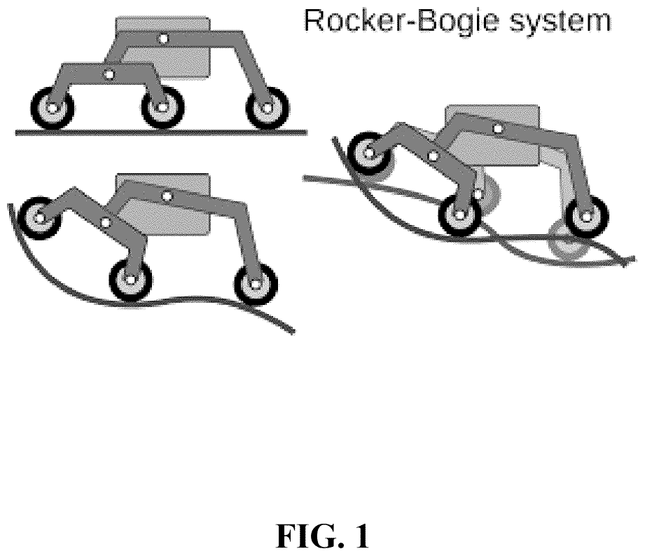

Referring to FIG. 1, an example of a conventional rocker-bodie system is depicted. The rocker-bodie system includes a rocker coupled to a bodie, one or more wheels coupled to each of the rocker and the bodie, and a unit coupled to the rocker. The rocker-bodie system is depicted in two terrains: horizontal terrain and inclined terrain. The relative motion between the rocker and the bodie of the rocker-bodie system in the inclined terrain is also depicted.

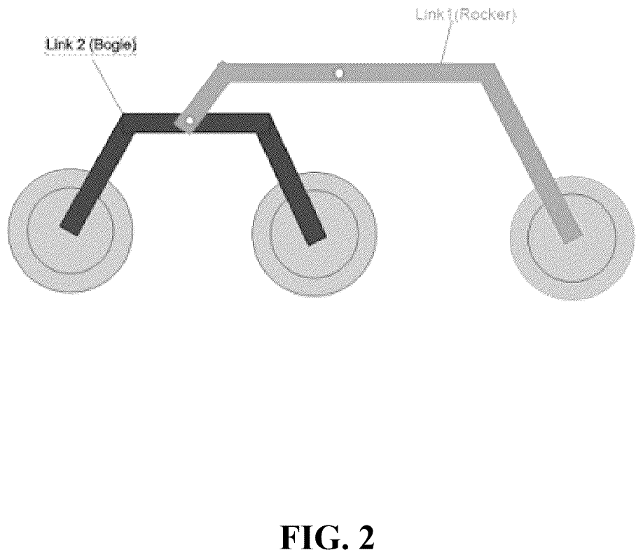

Referring to FIG. 2, an example of a conventional rocker-bodie system is depicted. The rocker-bodie system includes a rocker (labeled “Link 1”) coupled to a bodie (labeled “Link 2”) and one or more wheels coupled to each of the rocker and the bodie.

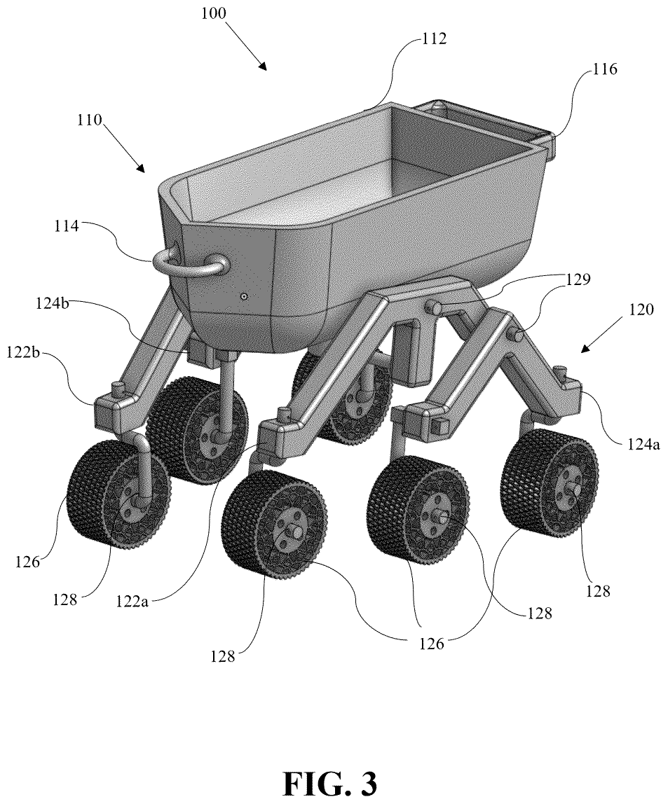

Referring to FIG. 3, a ground transportation vehicle 100, according to an embodiment, comprises a container 110 and a suspension system 120 fixedly couplable to the container 110. Container 110 may include a bucket 112 having an internal recess, a hook 114 fixedly couplable to a front side of the bucket 112, and a handle 116 fixedly couplable to a rear side of the bucket 112. Supplies or other items may be placed in the internal recess of bucket 112 and transported from one location to another. Hook 114 is configured to receive a chain or rope so that a user may pull ground transportation vehicle 100. Alternatively, ground transportation device 100 may be pulled or pushed from the rear using handle 116. Handle 116 is also configured to receive a chain or rope should a user wish to pull ground transportation vehicle 100 using an alternative approach. Container 110 may be manufactured from materials including, but not limited to, metals, plastics, composites, woods, or combinations thereof.

Suspension system 120 may include first and second rockers 122a,b, first and second bogies 124a,b, a plurality of wheels 126, a plurality of wheel connectors 128, and one or more variable fasteners 129. First rocker 122a is positioned on a side of container 110 with second rocker 122b positioned on the opposite side. First and second rockers 122a,b are fixedly couplable to bucket 112 via welding or another suitable connection mechanism. First and second bogies 124a,b are removably couplable to first and second rockers 124a,b, respectively, via one or more variable fasteners 129. First and second rockers 122a,b and bogies 124a,b may be manufactured from materials including, but not limited to, metals, plastics, composites, woods, or combinations thereof. Variable fasteners 129 are conventional and well known to a person of ordinary skill.

First and second rockers 122a,b and bogies 124a,b may include one or more apertures for receiving wheel connectors 128 and variable fasteners 129. Each wheel connector 128 is operably couplable to a wheel 126 with first and second rockers 122a,b generally having one wheel and first and second bogies 124a,b generally having two wheels. Wheel connectors 128 may be manufactured from materials including, but not limited to, metals, plastics, composites, woods, or combinations thereof. Wheels 126 are conventional and well known to a person of ordinary skill.

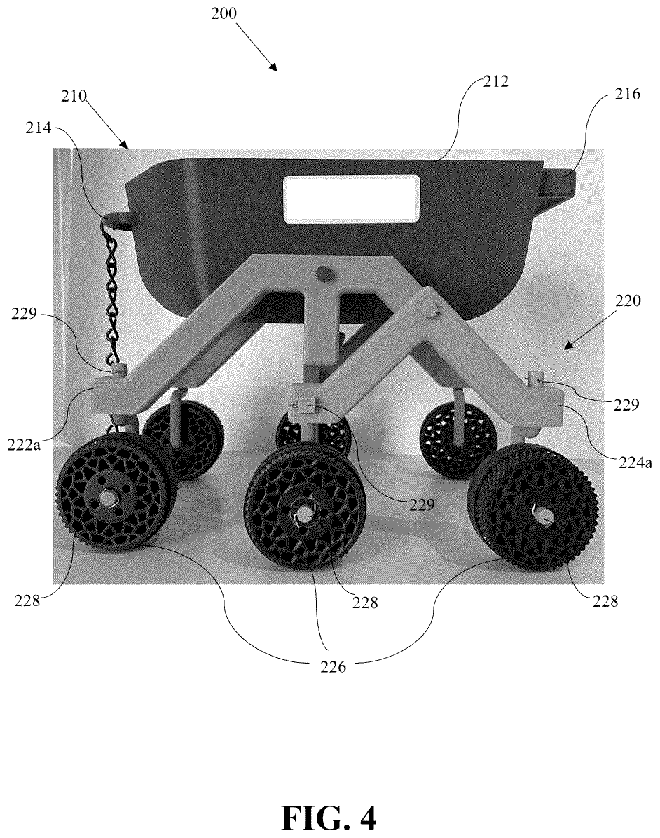

Referring to FIG. 4, a ground transportation vehicle 200, according to an embodiment, has many similarities to ground transportation vehicle 100 and for simplicity the description of common components is not repeated in the following, and like numerals may designate like parts throughout that are corresponding or analogous. An optional chain (not numbered) is shown connected to hook 214 for pulling ground transportation vehicle 200. It should be understood that a chain or rope or other pulling mechanism may be used with all ground transportation vehicle embodiments depicted herein.

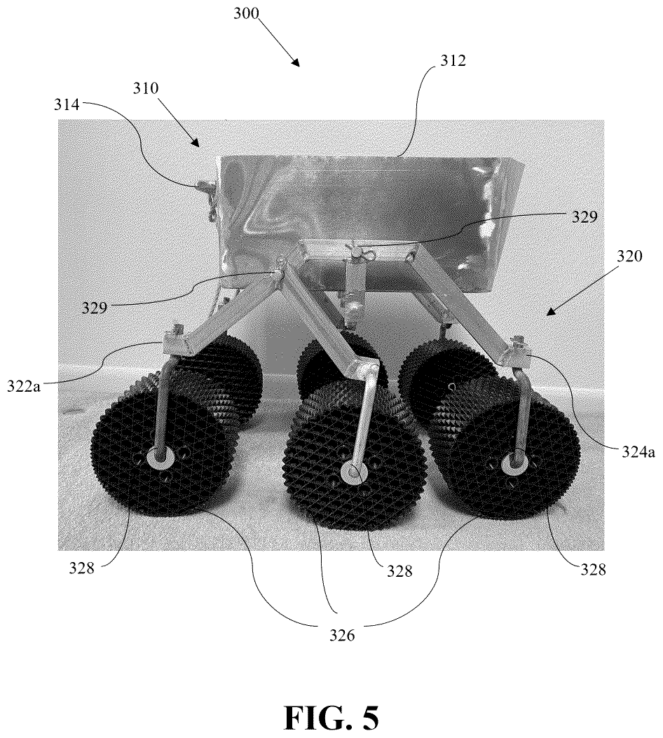

Referring to FIG. 5, a ground transportation vehicle 300, according to an embodiment, has many similarities to ground transportation vehicle 100 and for simplicity the description of common components is not repeated in the following, and like numerals may designate like parts throughout that are corresponding or analogous.

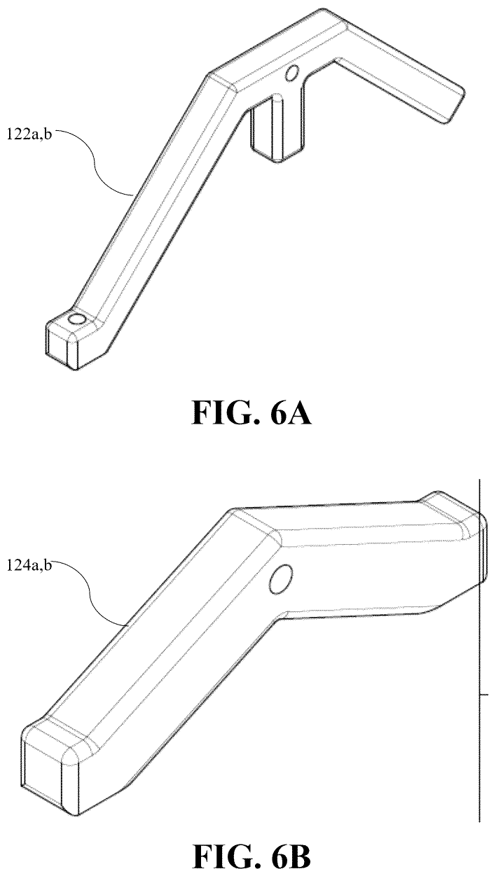

Referring to FIG. 6A, a geometrical representation of a typical rocker 122a,b showing several connected segments and two apertures is provided. Referring to FIG. 6B, a geometrical representation of a typical bogie 124a,b showing two angled segments, two horizontal segments, and a single aperture is depicted.

In further embodiments, ground transportation vehicles 100, 200, 300 may include electrical components and/or electrical circuitry to allow automatic transportation of relief supplies from a distribution site using vehicles 100, 200, 300 rather than manual transportation by the disaster victim using a chain or rope or handles 116, 216, 316.

In further embodiments, a method 400 of operating a ground transportation vehicle 100 comprises supplying a ground transportation vehicle 100 at a distribution site, adding supplies to the container 110 of the ground transportation vehicle 100, delivering the ground transportation vehicle 100 to a disaster victim, transporting the supplies to the disaster victim's home or present lodging location via the ground transportation vehicle 100, and returning the ground transportation vehicle 100 to the distribution site. Optionally, container 110 may be removed by the disaster victim prior to returning the ground transportation vehicle 100 to the distribution site. A new container 110 may then be added to the ground transportation vehicle 100 at the distribution site prior to servicing another disaster victim with relief supplies. It should be appreciated that method 400 can be accomplished in a similar manner using ground transportation vehicles 200, 300.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A ground transportation vehicle, as shown and described herein.

2. A method of operating a ground transportation vehicle, as shown and described herein.
